(19) United States
(12) Patent Application Publication
(10) Pub. No.: US 2026/0194492 A1
(43) Pub. Date: Jul. 9, 2026

(54) INSPECTION SYSTEM AND METHOD FOR IN-SITU DETECTION OF CHARACTERISTICS WITHIN SOLIDIFIED POWDER MATERIAL

(71) Applicants: FRAUNHOFER-GESELLSCHAFT ZUR FOERDERUNG DER ANGEWANDTEN FORSCHUNG E.V., Muenchen (DE); BUNDESANSTALT FUER MATERIALFORSCHUNG UND -PRUEFUNG (BAM), Berlin (DE)

(72) Inventors: Dennis JUTKUHN, Hamburg (DE); Ralf CASPERON, Berlin (DE); Henrik EHLERS, Berlin (DE); Matthias PELKNER, Berlin (DE); Roland THEWES, Puchheim (DE)

(21) Appl. No.: 19/128,289

(22) PCT Filed: Nov. 2, 2023
(86) PCT No.: PCT/DE2023/100806

§ 371 Date: May 8, 2025

(30) Foreign Application Priority Data
Nov. 15, 2022 (DE) 10 2022 130 223.7

(51) Int. Cl. G01N 27/90; B22F 10/85; B22F 12/60; B33Y 30/00; B33Y 50/02; G06T 7/00; G06V 10/98

(52) U.S. Cl. CPC G01N 27/90; B22F 10/85; B22F 12/60; B33Y 30/00; B33Y 50/02; G06T 7/0004; G06V 10/993; G06T 2207/30108; G06V 2201/06

(57) ABSTRACT

The invention relates to an inspection system (200) for in-situ detection of characteristics (114, 116) within solidified powder material (104) by means of a high-energy beam (128), comprising an eddy current-based inspection unit (202) that can be arranged on a moving unit (110) and which is arranged and configured to detect a material property of solidified powder material (104) by means of an eddy current inspection so that conductivity differences within the solidified powder material (104) can be detected in order to identify characteristics (114, 116) during additive manufacturing, wherein the inspection unit (202) comprises a first eddy current sensor unit (210) being arranged and configured to identify a characteristic having a first characteristic size greater than or equal to a size threshold, in particular a single defect, and wherein the inspection unit (202) comprises a second eddy current sensor unit (230) being arranged and configured to identify an aggregate of characteristics having a second characteristic size smaller than the size threshold, in particular a porous defect region.

The invention relates to an inspection system and a method for in-situ detection of characteristics within solidified powder material, as well as a manufacturing system.

Inspection systems for in-situ detection of characteristics within solidified powder material are known in principle. During the additive producing of components from a powder material, the powder material is solidified in order to produce the component layer by layer. The powder material can be solidified, for example, by means of a high-energy beam, in particular a laser beam, or a binder.

Thermographic methods can be used to detect defects, for example, but the amount of data is so extensive that real-time evaluation is not possible or only possible to a limited extent. Furthermore, no repetitive tests are possible. In addition, particles in the beam path falsify the results. Another disadvantage of thermographic methods is that the required test setup is comparatively expensive.

Furthermore, it is possible to test solidified powder material using ultrasound. One disadvantage of the ultrasound method is that the achievable test resolution is usually insufficient. In addition, ultrasound probes can only be placed below the base plate, so that limited accessibility must be taken into account.

Using computed tomography, defects can usually be precisely determined. However, computed tomography is not applicable in situ and is comparatively expensive. Furthermore, radiation protection is required during the test.

Acoustic emission analysis can usually be used to detect defects, but the exact position of the defect can only be determined to a limited extent. Furthermore, there is usually no possibility of a repeat test. In addition, hidden defects cannot be detected using optical methods.

US 2016/9215 A1 discloses a system for the non-destructive testing of components produced by additive manufacturing, in which an electromagnetic field is applied. In this case, an eddy current test is carried out, but a structure is proposed that offers such limited spatial resolution that it is not possible to precisely determine differently configured defects in a solidified powder material.

DE 10 2016 201 290 A1, DE 10 2011 111 818 A1, EP 3 632 595 A1 and US 2018/0264590 A1 disclose devices for the additive manufacturing of components with inspection units.

There is a demand from industry for additive manufacturing processes with a low reject rate and high quality in order to reduce the downstream inspection effort, among other things. In particular, the currently often applied computed tomography, for example for components in medical technology or aerospace technology, leads to high costs and/or a high time commitment. Furthermore, it is a requirement to raise the process stability in additive manufacturing to a comparable level of conventional manufacturing, since additive manufacturing offers particular advantages in terms of resource utilization.

It is therefore an object of the invention to provide an inspection system and a method for in-situ detection of characteristics within solidified powder material and a manufacturing system that reduce or eliminate one or more of the disadvantages mentioned. In particular, it is an object of the invention to provide a solution that enables reliable in-situ detection of characteristics in a solidified powder material.

This problem is solved by means of an inspection system and a method according to the features of the independent claims. Further advantageous embodiments of these aspects are indicated in the respective dependent claims. The features disclosed in the claims, the description and the drawings can be combined with each other individually, in any technologically meaningful way, whereby further embodiments of the invention are indicated.

According to a first aspect, the above-mentioned problem is solved by an inspection system for in-situ detection of characteristics within solidified powder material, comprising an eddy current-based inspection unit that can be arranged on a moving unit and that is arranged and configured to detect an electromagnetic material characteristic of solidified powder material by means of an eddy current inspection, so that conductivity differences within the solidified powder material can be detected in order to identify characteristics, wherein the inspection unit comprises a first eddy current sensor unit that is arranged and configured to identify a characteristic having a first characteristic magnitude that is greater than or equal to a size threshold, in particular a single defect, and wherein the inspection unit comprises a second eddy current sensor unit being arranged and configured to identify a collection of characteristics having a second characteristic size smaller than the size threshold, in particular a porous defect region.

The invention is based on the findings that single defects and clusters of micro-defects are the most common causes of scrap in powder-based additive manufacturing. Furthermore, the invention was based on the finding that different eddy current-based mechanisms are required to test the characteristics mentioned above in order to ensure reliable identification. This finding can be technically and advantageously utilized by using two different eddy current sensor units, namely the first and second eddy current sensor units, which are configured to identify characteristics with different characteristic sizes.

The inspection system thus enables in-situ adjustment, in particular a correction, of the identified characteristics, as will be explained in more detail below. Furthermore, a construction order or a component can be aborted during production and after detection of a characteristic, so that the cost-intensive additive production is aborted after the production of a non-adaptable or non-correctable characteristic. In addition, the inspection system offers the advantage that no complex inspection steps are required after the component has been completed, which usually involve high costs with computed tomography.

Another advantage of the eddy current-based method is that the amount of data generated is so small that the data evaluation can be carried out during the additive manufacturing process, whereby a process control system based on the results of the inspection system can be designed to be real-time capable. Furthermore, the characteristics can be assigned layer by layer. Furthermore, the in-situ recording of the characteristics can be used to derive a correlation between the characteristic and the applied process parameters as well as with process conditions determined by sensors of the manufacturing system, so that the additive manufacturing process can be optimized. In particular, this can be done, for example, with artificial intelligence. Furthermore, the process can be loop-controlled in situ, as will be explained in more detail below. In addition, process interruptions and abortions are reduced by increasing process stability. Furthermore, such testing enables digital manufacturing documentation.

The inspection system is designed to detect characteristics within solidified powder material in situ. Solidified powder material refers to any powder material whose powder particles are joined to one another, at least in sections. For example, solidified powder material can be formed by joined and/or glued powder particles. The powder material to be solidified is configured in particular to be electrically conductive and/or ferromagnetic. In-situ testing and detection of characteristics is understood in particular to mean testing during the process of producing the component from the powder material, for example in layers at single or multiple points in time between the generation of a first layer and the generation of a last layer of the component.

Characteristics are understood in principle to mean all characteristics within solidified powder material. A characteristic may, for example, be an inhomogeneity or an anomaly. For example, a characteristic may be a cavity, for example due to incomplete melting, a gas pore, a microporosity, a material property, a delamination, a geometric deviation, a reduced surface quality, a discoloration and/or characteristics in the material structure. Furthermore, a characteristic can be a geometry, a component edge or a contour of the solidified powder material or of the component.

The inspection system is configured in particular for powder bed-based additive manufacturing processes. The inspection system is particularly suitable for an additive layer manufacturing process, for example for selective laser beam melting (L-PBF), selective electron beam melting (E-PBF) or metal binder jetting (MB)). The powder material can be solidified, for example, with a high-energy beam and/or a binder. The high-energy beam is preferably a laser or electron beam. A consolidated powder material is understood to mean, in particular, a powder material whose powder particles are at least partially bonded to one another, in particular fused to one another.

The inspection system comprises the eddy current-based inspection unit. An eddy current-based inspection unit is basically understood to be an inspection unit that is arranged and configured to detect a characteristic based on an eddy current inspection. The inspection unit is preferably arranged and configured to generate an alternating magnetic field that penetrates a surface to be inspected, generates an eddy current within the material, and measures the reaction of this eddy current and uses it for material testing.

The generated eddy current counteracts the generating current with its own magnetic field, so that these differences can be detected by the inspection unit. In particular, the eddy current-based inspection unit can be used to detect differences in the electromagnetic properties within the solidified powder material. For example, a pore has a different electrical conductivity from the solidified powder material surrounding it. Thus, a detected difference in electrical conductivity can be used to draw a conclusion about a characteristic.

When the inspection system is used as intended, the inspection unit can, for example, induce an eddy current in the solidified powder material. The reaction of this eddy current is then measured. Furthermore, changes in the eddy current can be detected and, on this basis, conductivity differences can be detected. A corresponding evaluation of the detected conductivity differences in turn allows conclusions to be drawn about characteristics, in particular defects. As an alternative to the inspection unit that induces the eddy current, an additional excitation unit can also be provided.

The inspection unit can be arranged on a moving unit. This means, in particular, that the inspection unit is designed to be arranged on a moving unit that can be moved over a powder bed.

The eddy current-based inspection unit is arranged and configured to detect an electromagnetic material property of solidified powder material by means of an eddy current inspection. Thus, differences in conductivity within the solidified powder material can be detected in order to identify characteristics. It is particularly preferred that changes in the electromagnetic material property be detected.

The inspection unit comprises the first eddy current sensor unit. The eddy current sensor unit is arranged and configured, in particular in intended operation, to identify a characteristic with a first characteristic magnitude greater than or equal to a size threshold. In particular, the first eddy current sensor unit is arranged and configured to detect a single defect, such as a single pore. The first eddy current sensor unit is preferably arranged and configured to measure a magnetic field at the eddy current sensor unit, which is influenced by the course of the eddy currents in the solidified powder material. An eddy current path disturbed by a characteristic in the solidified powder material leads to a measurement effect at the location of the sensor. In particular, the first eddy current sensor unit is configured in order to identify larger characteristics. Therefore, the first eddy current sensor unit is configured to identify characteristics that are greater than or equal to the size threshold. It is preferred that the first eddy current sensor unit be miniaturized. Preferably, the first eddy current sensor unit comprises one, two or more eddy current sensors.

The inspection unit also comprises the second eddy current sensor unit. The second eddy current sensor unit is arranged and configured to identify a collection of characteristics. A collection of characteristics may, for example, be a porosity formed by micropores, for example. The second eddy current sensor unit is preferably configured to measure an impedance of an eddy current coil in order to detect a change in impedance caused by a counter-field of the eddy currents. The second eddy current sensor unit preferably has an integrating behavior so that regions of defects can be advantageously identified. The second eddy current sensor unit is preferably miniaturizable. Preferably, the second eddy current sensor unit comprises one, two or more eddy current sensors.

The inspection unit, the first eddy current sensor unit and/or the second eddy current sensor unit are or are preferably configured to generate characteristic signals representing a characteristic. A signal is understood to mean any type of information carrier. The characteristic signal can, for example, be configured as a data set. The characteristic signal is preferably provided permanently, so that a change in the characteristic signal indicates a characteristic.

In particular, a signal strength, preferably a constant signal strength, can be used to draw conclusions about characteristics of the solidified powder material. An offset in the signal strength can characterize a reduction in the material density. In order to maximize this value, parameter variations can be carried out to obtain an optimum, in particular to maximize the density of the component.

Furthermore, the inspection unit, the first eddy current sensor unit and/or the second eddy current sensor unit are preferably configured to provide the characteristic signals to a control device. The control device, as will be explained in more detail below, is preferably adapted to identify and classify characteristics. On this basis, characteristics can, if technically possible, be adapted, in particular corrected, as is possible with the adaptation signal explained in more detail below.

The first eddy current sensor unit and the second eddy current sensor unit have, in particular, individual sensors that are arranged and configured to generate and provide test signals on the basis of which conductivity differences can be detected, so that the electromagnetic material properties can be detected.

It is preferred that sensor data from the first eddy current sensor unit and the second eddy current sensor unit can be evaluated in combination, in order to enable improved detection of characteristics based on the combined evaluation. This is preferably done by superimposing the sensor data and/or by data fusion, whereby the testability of the test system can be extended.

It is preferred that the first eddy current sensor unit has a first control unit and/or the second eddy current sensor unit has a second control unit and/or the inspection system has a control device that is adapted to recognize conductivity differences within the solidified powder material and to identify characteristics based on test signals from the first eddy current sensor unit and/or the second eddy current sensor unit. It is preferred that the first control unit and/or the second control unit and/or the control device are adapted to generate and/or provide a characteristic signal representing the identified characteristic.

A preferred further development of the inspection system is characterized in that the first eddy current sensor unit and/or the second eddy current sensor unit are arranged and configured to effect a sensor movement in a secondary direction, the secondary direction being oriented non-parallel to a main direction, in particular a feed direction, of the movement unit. It is preferred that the first eddy current sensor unit and/or the second eddy current sensor unit is arranged to be movable in the secondary direction. Alternatively or additionally, individual sensors of the first eddy current sensor unit and/or of the second eddy current sensor unit can be arranged to be movable in the secondary direction. For example, a magnetic field sensor of the first eddy current sensor unit can be moved laterally back and forth during the test by a drive, in particular a linear motor, so that a zigzag movement is generated during the test. This would improve a geometric test, for example. The technical effect of the secondary motion is, among other things, that the directional dependence of the resolution is reduced, and the resolution is improved.

It is preferred that the first eddy current sensor unit has multi-rowly arranged excitation elements, for example excitation wires, which are arranged in such a way that excitation currents oriented at an angle to one another can be effected with these, in order to improve the identification of characteristics.

In a preferred embodiment of the test system, the first eddy current sensor unit is provided with a first test resolution and the second eddy current sensor unit is provided with a second test resolution, wherein the first test resolution is higher, in particular many times higher, than the second test resolution.

The first and second inspection resolutions are to be understood in particular as a measure of the level of detail of the inspection carried out using the first eddy current sensor unit and the second eddy current sensor unit. The higher the inspection resolution of the eddy current sensor units is configured, the more accurately the inspection can be carried out and the smaller the identifiable characteristics can be. Furthermore, inspection resolution can be understood to mean a maximum measuring point distance.

It is preferred that the first inspection resolution is less than 100 micrometers. Furthermore, it may be preferred that the second inspection resolution is less than 1 millimeter.

Another preferred configuration of the inspection system is characterized by the size threshold being between 15 micrometers and 100 micrometers, in particular between 20 micrometers and 50 micrometers. It has been found that a selection of a first eddy current sensor unit and a second eddy current sensor unit, which are distinguished by this size threshold and/or their local inspection resolution, are particularly suitable for detecting the different characteristics in solidified powder material.

In a further preferred embodiment of the inspection system, the first eddy current sensor unit is or comprises a magnetic field sensor. Preferably, the first eddy current sensor unit comprises a plurality of magnetic field sensors. The magnetic field sensors can be arranged as an array. The magnetic field sensor may, for example, be a magnetoresistive sensor, a giant magnetoresistive (GMR) sensor, a magnetic tunnel resistance (TMR) sensor and/or a Hall sensor. Itis preferred that the magnetic field sensor is miniaturizable.

Furthermore, it may be preferred that the second eddy current sensor unit is or comprises an eddy current coil. The eddy current coil can be, for example, a printed coil. It is further preferred that the second eddy current sensor unit has two or more eddy current coils. It is preferred that in the second eddy current sensor unit, the eddy current coils are also used as an excitation unit.

In particular, the combination of magnetic field sensors and eddy current coils makes it possible to identify both major characteristics and minor characteristics in the form of an accumulation of micro-defects.

It is preferred that the magnetic field sensors be arranged at a distance from the eddy current coils so that the eddy current coils do not physically influence the magnetic field sensors or only influence them to a slight extent. Furthermore, the influence of the eddy current coils on the magnetic field sensors can be influenced by additional elements.

In a further preferred embodiment, it is envisaged that the inspection unit is arranged and configured to detect the electromagnetic material property by means of an eddy current inspection during the solidification, in particular of an exposure and/or a standstill and/or a movement of the movement unit. The inspection unit can, for example, be arranged in front of or behind the movement unit in the feed direction. The movement unit can, for example, be a coating unit.

Another preferred advanced development of the inspection system is characterized by the fact that it comprises a control device coupled by signals to the inspection unit, which is adapted to in particular a single defect and/or a porous defect area, to generate an adaptation signal, in particular a correction signal, which represents an adaptation strategy, in particular a correction strategy, of the manufacturing system for adapting, in particular for eliminating, the characteristic.

The adaptation signal is understood to mean any type of information carrier that is suitable for effecting the adaptation strategy of the manufacturing system. For example, the adaptation signal can be configured as a data record and/or represent a command. Furthermore, the adaptation signal can be based on an identification and/or classification of the characteristic, in particular the individual defect and/or the defect area.

Furthermore, it is preferred that the control device is adapted to optimize parameters of the manufacturing system based on the identified characteristics and/or based on the adaptation signal, so that the generation of characteristics is reduced or avoided.

The control device is preferably adapted such that the adaptation signal effects an adaptation of manufacturing and/or machine parameters and/or process conditions. For example, the adaptation signal can cause process parameters, such as scanner, exposure, binding and coating parameters, gas flow, preheating and/or building chamber pressure, to be adapted.

Furthermore, the adaptation signal can cause a renewed exposure and/or binding, in particular an adapted exposure and/or binding, of characteristics. The adaptation signal can also cause a change in the scanning strategy and/or a scanning pattern, a change in an exposure sequence, a change in a temporal sequence of exposure, a renewed application of powder, an adaptation of the building platform stroke or the layer thickness. Furthermore, the adaptation signal can represent or cause the cancellation of individual components or an entire construction order.

The inspection system thus enables the adjustment, in particular the correction, of a characteristic of the currently generated layer, whereas existing approaches usually only enable the characteristic to be influenced by further layers that have already been generated. This enables a more direct and targeted influence on the characteristics. Furthermore, the inspection system not only makes it possible to identify defects and check the integrity of the component and to record the condition of the material properties within the inspection depth, but also to derive targeted measures to actively eliminate the defects and to check whether the elimination was successful. This is where the repeatability of the inspection comes into play. No other in-situ inspection system enables direct inspection, derivation of measures, targeted healing and verification of this healing.

In a preferred training of the inspection system, it is envisaged that the control device is adapted to control the inspection unit in such a way that a predefined number of layers, in particular at predefined layer positions, are inspected. For example, an inspection system configured in such a way makes it possible to inspect layers 50 to 500 of a build job while the remaining layers are not inspected due to their irrelevance to component quality. This may be the case, for example, if the first layers are intended to attach the component to a build platform and their characteristics are therefore not relevant. This further reduces the amount of data generated.

A preferred embodiment of the inspection system is characterized in that the inspection unit is arranged and configured to identify an adapted characteristic based on the adaptation signal. Furthermore, it may be preferred that the control device is adapted to generate a second adaptation signal based on the identified adapted characteristic, which represents a second adaptation strategy of the manufacturing system for further adapting the adapted characteristic.

In a further preferred embodiment of the inspection system, it is provided that it comprises an excitation unit for effecting the eddy current in the solidified powder material, wherein in normal operation one excitation unit or two excitation units on either side of the first eddy current sensor unit are arranged at an equal distance from the test surface.

This arrangement allows the eddy current sensor units to be positioned particularly close to the test surface, in particular a powder bed surface, so that eddy current testing is favorably enabled. The excitation unit is preferably arranged and configured to induce the eddy current such that it has a penetration depth greater than 100 micrometers, preferably more than 200 micrometers.

During normal operation, the eddy current sensor units are located between the powder bed and the excitation unit and/or in the same plane as the excitation unit parallel to the surface of the powder bed.

In a further preferred embodiment of the inspection system, it is provided that this has a topography measuring system for determining a topography of the solidified powder material, in particular a surface of the solidified powder material, which is adapted to generate a topography signal characterizing a topography image that represents a distance of the solidified powder material to the inspection unit, wherein the characteristic is further identified based on the topography image.

The topography measuring system can, for example, be a unit for stripe light projection, a line scanner and/or a light field camera. The distance between the solidified powder material and the inspection unit is determined in particular between the surface of the solidified powder material and the first and/or second eddy current sensor unit, in particular their individual sensors.

Another preferred embodiment of the inspection system is characterized in that the first eddy current sensor unit and the second eddy current sensor unit are arranged offset to one another. For example, these may have a pitch or distance. Furthermore, these can be arranged in several rows. It is particularly preferred that the first eddy current sensor unit and the second eddy current sensor unit are arranged horizontally offset to each other in the intended operation. In particular, the individual sensors of the second eddy current sensor unit are arranged offset with respect to one another. In the intended use, the individual sensors can be arranged offset with respect to one another orthogonally to a main direction of movement, in particular in the feed direction, of the movement unit.

In a further preferred embodiment of the inspection system, the first eddy current sensor unit and/or the second eddy current sensor unit have individual sensors, in particular the magnetic field sensors and/or eddy current coils, that are arranged and configured in such a way that they can be supplemented by at least one further individual sensor. With such an arrangement and design of the eddy current sensor units, these can be individually expanded so that various requirements of additive manufacturing can be addressed.

In another preferred embodiment, the inspection system has an application-specific integrated circuit that is coupled by signals to the inspection unit and is adapted to amplify, digitize, filter and/or provide signals recorded by the first eddy current measuring unit and/or the second eddy current measuring unit for further processing.

One advantage of the application-specific integrated circuit is its high integration density, so that it takes up only a small amount of space, allowing the inspection unit to be miniaturized.

In a further preferred embodiment of the inspection system, the control device is adapted to identify a component edge and/or a contour of the component, in particular of the consolidated powder material, based on output signals from the first and/or second eddy current sensor unit. The inspection system is advantageous for detecting component edges and contours because loose powder material acts as an insulator when the first and/or second eddy current sensor unit is measuring. This makes it possible to intelligently superimpose and process both signals.

According to a further aspect, the problem mentioned at the start is solved by a manufacturing system for additively producing a component by consolidating a powder material, comprising a build chamber in which the powder material can be arranged, a consolidation unit that is arranged and configured to consolidate the powder material, in particular with a high-energy beam or a binder, a movable movement unit arranged above the powder material to be consolidated, and an inspection system according to one of the embodiments described above, wherein the inspection unit is arranged on the movement unit.

The manufacturing system can preferably be controlled by means of the control device of the testing system described above. Alternatively, the manufacturing system can have a control unit that receives and/or generates the adaptation signal mentioned above, and the manufacturing system can be controlled by means of the adaptation signal. The manufacturing system can be controlled or loop-controlled in parallel with the process by means of the inspection system described above, so that the detected characteristics of the layer currently being produced and/or one of the previously produced layers are adapted, in particular corrected, or a component or a build job is aborted.

The solidification unit is preferably configured as an exposure unit for exposing the powder material. Alternatively or in addition, the solidification unit is configured to apply a binder.

In a preferred embodiment of the manufacturing system, the movement unit is configured as a coating unit for forming a powder bed surface. The coater unit has, for example, a smoothing function in order to form a flat powder bed surface. This function can be configured, for example, with a coater lip. In addition, the coater unit can have a powder material supply or be coupled to a powder material store in such a way that the powder material can be supplied to the coater unit. The arrangement of the inspection unit on the coater has the advantage that the coater regularly passes over the powder bed, thus enabling a complete inspection of the consolidated powder material in parallel with the process. In particular in the case of a unidirectional layer application, it is preferred that the inspection unit performs a first inspection on an outward path and a second inspection on a return path to a starting position.

In a further preferred embodiment, the moving unit is configured as at least one handling system, in particular a robot, for example with at least one robot arm. The handling system is preferably arranged and configured to test those sections that are accessible while the powder material is still being solidified. The testing process would be partially or completely parallelized with the solidification process. Furthermore, it is preferred that the movement unit is or comprises the solidification unit.

According to a further aspect, the problem mentioned at the beginning is solved by a method for in-situ detection of characteristics within solidified powder material, in particular with an inspection system according to one of the design variants described above, comprising the steps of: detecting an electromagnetic material characteristic of solidified powder material by means of an eddy current inspection, such that conductivity differences within the solidified powder material are detected in order to identify characteristics, wherein a first eddy current sensor unit is used to identify a characteristic with a first characteristic magnitude greater than or equal to a size threshold, in particular a single defect, and wherein a collection of characteristics with a second characteristic size smaller than the size threshold, in particular a porous defect area, are identified with a second eddy current sensor unit.

It is preferred that test signals be generated on the basis of which conductivity differences are detected so that the electromagnetic material property is detected. The detection of the material characteristic is preferably carried out with a first control unit of the first eddy current sensor unit and/or a second control unit of the second eddy current sensor unit and/or a control device. Furthermore, the identification of the characteristic is preferably carried out with the first control unit and/or the second control unit and/or the control device.

According to a preferred embodiment of the method, this comprises the steps of: generating an adaptation signal, in particular a correction signal, based on an identified characteristic, in particular a single defect and/or a porous defect area, the adaptation signal, in particular the correction signal, representing an adaptation strategy, in particular a correction strategy, of a manufacturing system for adapting the characteristic, and driving the manufacturing system with the adaptation signal, in particular the correction signal, in order to adapt the characteristic.

For further advantages, embodiments and details of the individual aspects and their possible further developments, please also refer to the description given for the further aspects, the corresponding features and further developments.

Preferred embodiments are explained by means of the accompanying figures. They show:

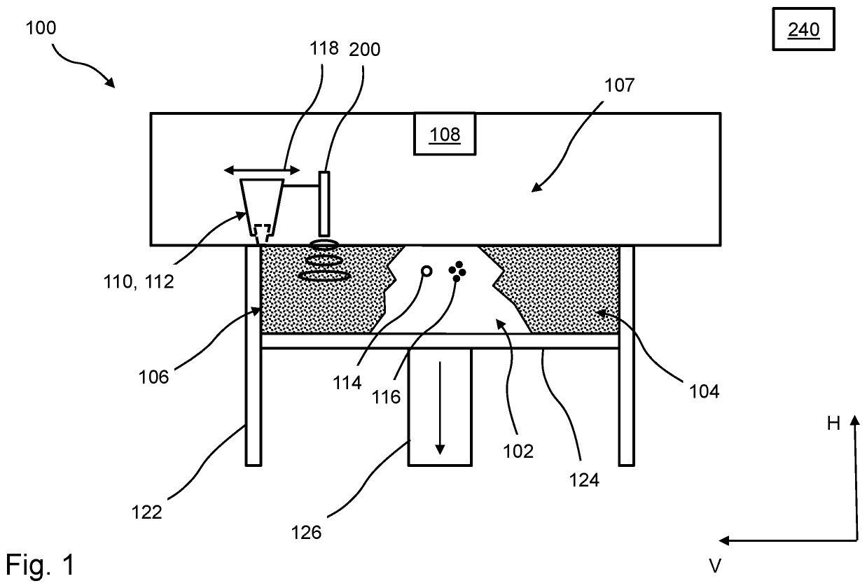

FIG. 1: a schematic, two-dimensional view of an exemplary embodiment of a manufacturing system;

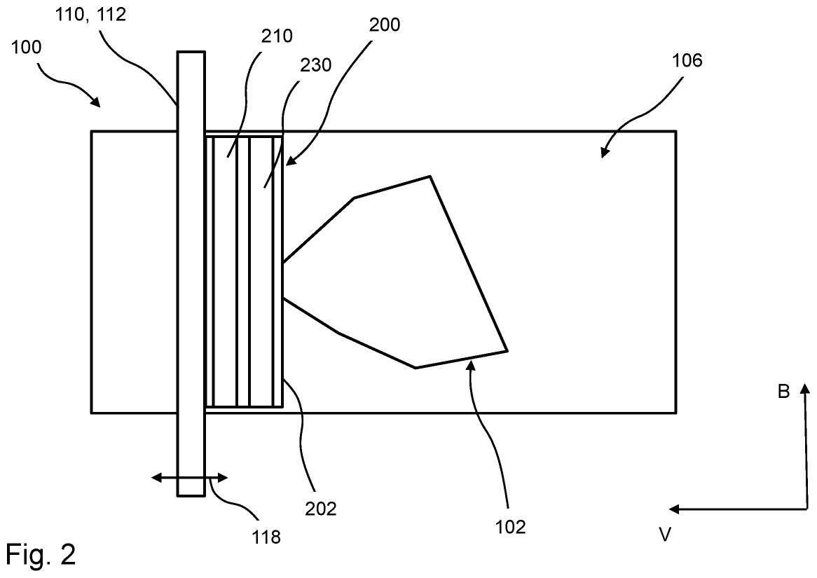

FIG. 2: a schematic, two-dimensional plan view of the manufacturing system shown in FIG. 1;

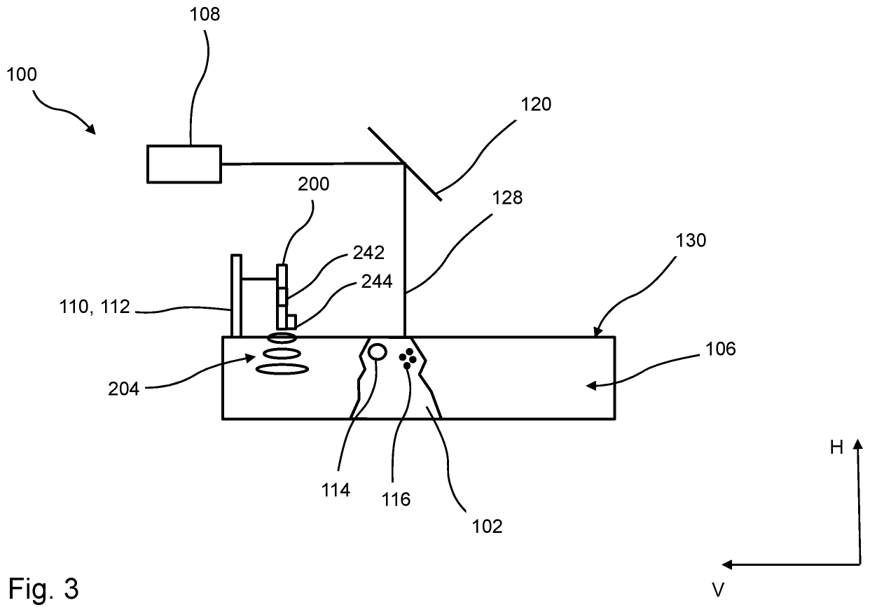

FIG. 3: a further schematic two-dimensional view of an exemplary embodiment of a manufacturing system;

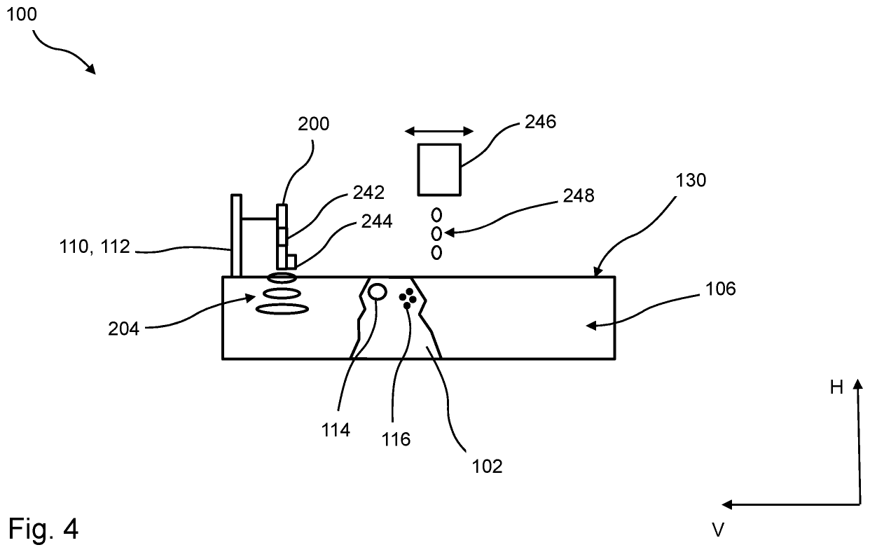

FIG. 4: a further schematic two-dimensional view of an exemplary embodiment of a manufacturing system;

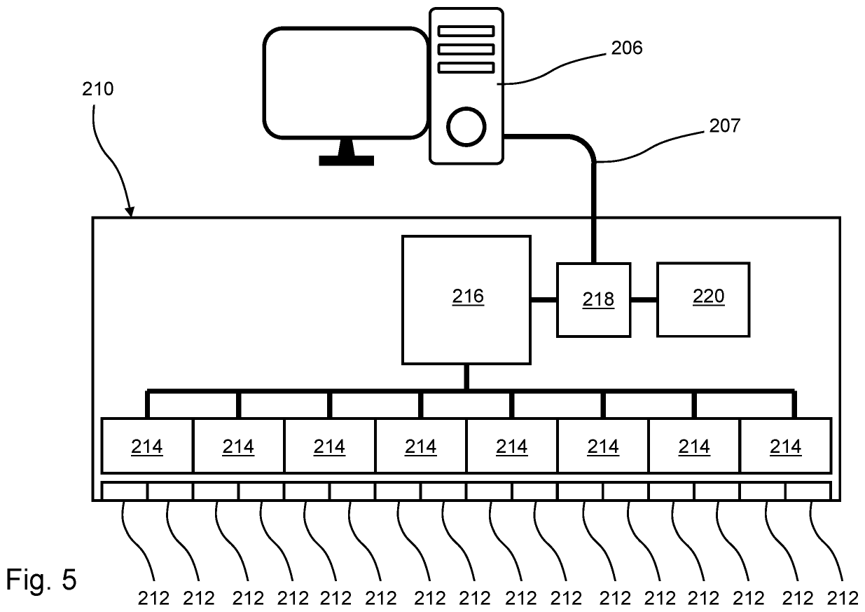

FIG. 5: a schematic two-dimensional view of an exemplary embodiment of a first eddy current sensor unit;

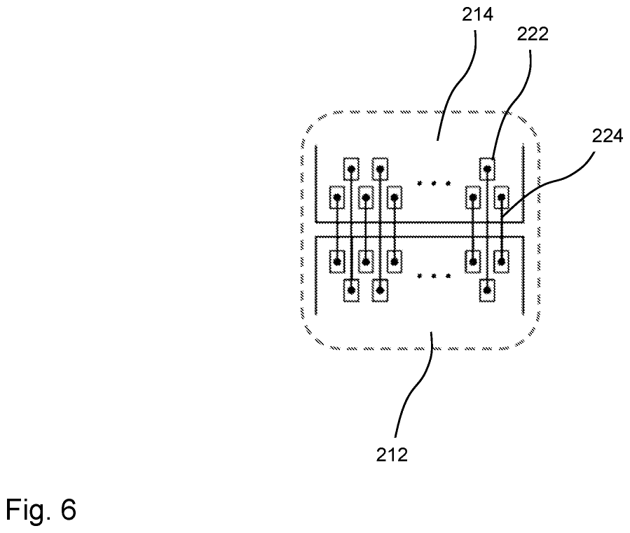

FIG. 6: a schematic two-dimensional view of an exemplary embodiment of a connection between a magnetic field sensor and an application-specific integrated circuit;

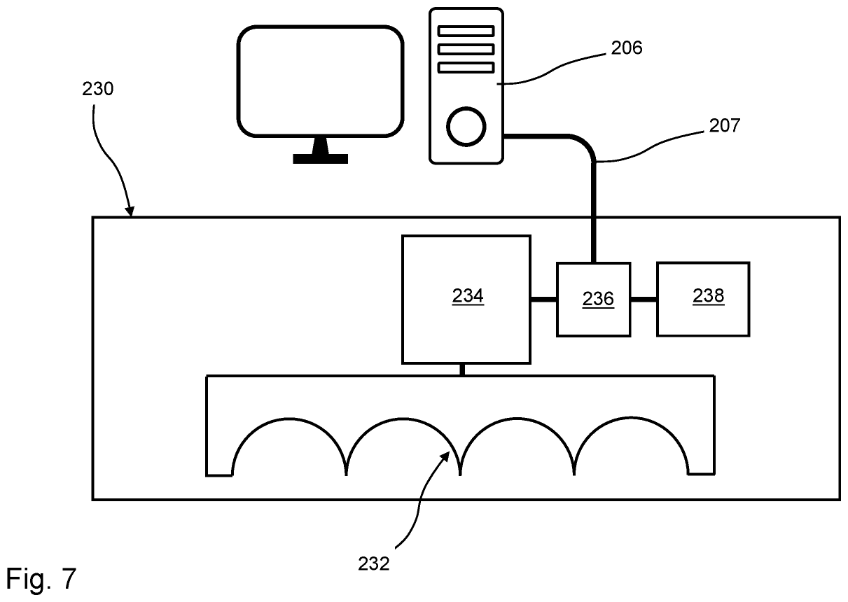

FIG. 7: a schematic two-dimensional view of an exemplary embodiment of a second eddy current sensor unit;

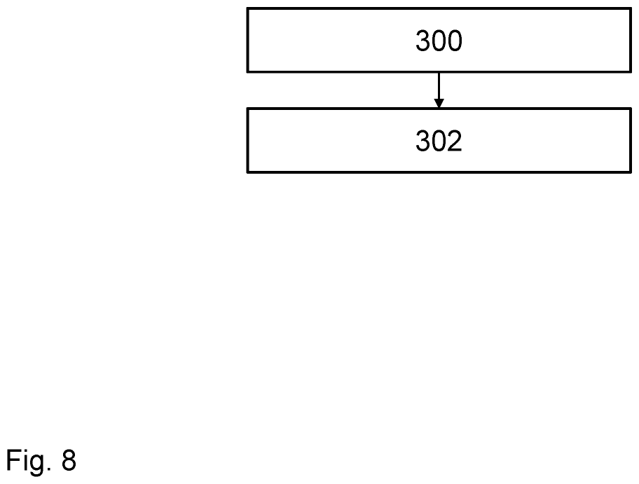

FIG. 8: a schematic view of an exemplary method; and

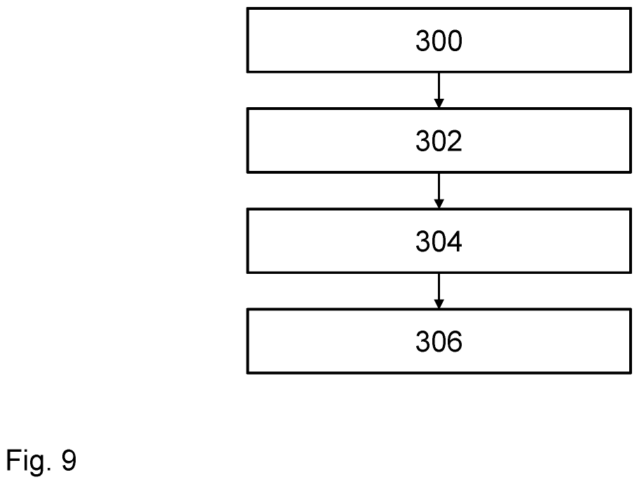

FIG. 9: a schematic view of a further exemplary method.

In the figures, identical or substantially identical or similar elements are designated by the same reference sign.

FIGS. 1 to 3 show a manufacturing system 100 for additively producing a component 102 by exposing a powder material 104. The component 102 is formed by solidified powder material 104. The powder material 104 is solidified using a high-energy beam 128. The high-energy beam 128 may, for example, be a laser beam. The component 102 is produced in the powder bed 106. For this purpose, the movement unit 110 configured as a coater 112 applies powder material 104 in layers, the thickness of the layer of powder material 104 being in the micrometer or millimeter range. The movement unit 110 is moved in the feed direction 118.

After a layer of the powder material 104 has been applied, it is selectively exposed to light by the exposure unit 108 and thereby usually melted. The table 124 with the adjustment unit 126 then moves down vertically by one layer thickness in order to allow the coater 112 to create a novel layer of the powder material 104. The system is arranged on a frame 122.

Exposing the powder material 104 to the high-energy beam 128 also regularly produces characteristics 114, 116. The characteristic 114 is shown as a single defect and the characteristic 116 is shown as a porous defect area with a large number of microdefects. This process takes place in the construction chamber 107.

FIG. 3 shows that a mirror element 120 is arranged in the beam path of the high-energy beam 128, which can be part of a scanner, for example. With the mirror 120, the high-energy beam 128 can be directed to any position of the test surface configured as a powder bed surface 130.

The manufacturing system 100 also includes the inspection system 200. The inspection system 200 is configured for in-situ detection of the characteristics 114, 116 within solidified powder material 102. The inspection system 200 comprises an eddy current-based inspection unit 202 arranged on the movement unit 110. The inspection unit 202 is arranged and configured to detect an electromagnetic material property of the solidified powder material 102 by means of an eddy current inspection, so that conductivity differences within the solidified powder material 102 can be detected in order to identify the characteristics 114, 116 during additive manufacturing. The eddy current 204 is caused by the inspection system 200 having an excitation unit 242 or an excitation unit not included in the inspection system 200.

The inspection unit 202 comprises a first eddy current sensor unit 210, which is arranged and configured to identify a characteristic 114 having a first characteristic size greater than or equal to a size threshold, in particular a single defect. In addition, the inspection unit 202 comprises a second eddy current sensor unit 230, which is arranged and configured to identify a collection of characteristics 116 with a second characteristic size smaller than the size threshold, in particular a porous defect area.

The inspection system 200 further comprises a control device 240 coupled by signals to the inspection unit 202, which is adapted to based on an identified characteristic 114, 116, generate a correction signal that represents a correction strategy of the manufacturing system 100 for remedying the characteristic 114, 116.

The inspection system 200 further comprises a topography measurement system 244 for determining a topography of the consolidated powder material 104. The topography measurement system 244 is adapted to generate a topography image that represents a distance of the powder bed surface 130 to the inspection unit 202, wherein the characteristic 114, 116 is further identified based on the topography image. The arrangement of the topography measuring system 244 on the coater 112 is optional, since the latter can also be arranged in such a way that it can measure the topography in the entire construction plane, for example from obliquely above the construction plane.

FIG. 4 shows a manufacturing system 100 that is essentially analogous to FIG. 3, wherein the solidification unit is configured as a binder unit 246 for applying a binder 248. Thus, a powder material 104 solidified by a metal binder jetting method can be inspected with the inspection system 200 described above.

FIG. 5 shows that the first eddy current sensor unit 210 comprises a plurality of magnetic field sensors 212. The magnetic field sensors 212 are connected in pairs to application-specific integrated circuits 214. This connection is shown in particular in FIG. 6, where these connections are formed by means of connection surfaces 222 and connection wires 224.

The application-specific integrated circuits 214 are further connected to an FPGA 216, a control element 218 and a memory element 220. The FPGA 216 can be used, for example, for pre-analysis and intermediate storage of the data generated by the magnetic field sensors 212 and for specifying a test frequency. The FPGA acts as an interface converter between the ASICs and other units of the system.

The control element 218 is also coupled to a computing unit 206 by means of a data connection 207.

FIG. 7 shows the second eddy current sensor unit 230 in detail. The second eddy current sensor unit 230 is analogous to the first eddy current sensor unit 210. The second eddy current sensor unit 230 comprises an eddy current coil 232, which is only shown schematically and is in turn coupled to an FPGA 234, a control element 236 and a memory element 238. The second eddy current sensor unit 230 preferably has several, preferably a plurality of, eddy current coils 232.

FIG. 8 shows a method for in-situ detection of characteristics 114, 116 within solidified powder material 102 using a high-energy beam 128. The method comprises the step 300: detecting an electromagnetic material characteristic of solidified powder material 102 by means of an eddy current inspection so that conductivity differences within the solidified powder material 102 are detected in order to identify characteristics 114, 116 during additive manufacturing. A first eddy current sensor unit 210 is used to identify a characteristic with a first characteristic size and a second eddy current sensor unit 230 is used to identify a collection of characteristics. In step 302, the characteristic 114 and/or the collection of characteristics 116 is recognized on the basis of the detected electromagnetic material property.

FIG. 9 shows a preferred embodiment of the method described above. In step 304, a correction signal is generated based on the identified characteristic 114, 116, in particular a single defect and/or a porous defect area, the correction signal representing a correction strategy of a manufacturing system 100 for eliminating the characteristic 114, 116. In step 306, the manufacturing system 100 is controlled using the correction signal in order to correct the characteristic 114, 116.

The inspection system 200 and corresponding method described above enable particularly advantageous detection of characteristics 114, 116 in a component produced from powder material 104. In particular, different property sizes can be reliably identified. Furthermore, the inspection system and the method enable a process-parallel control or regulation of an additive manufacturing process, since the generated and required amount of data is so small that real-time control is possible.

### REFERENCE SIGNS

100 manufacturing system
102 component
104 powder material
106 powder bed
107 construction chamber
108 exposure unit
110 movement unit
112 recoater
114 characteristics
116 characteristics
118 recoater feed
120 mirror element
122 frame
124 table
126 adjustment unit
128 high-energy beam
130 powder bed surface
200 inspection system
202 eddy current-based inspection unit
204 eddy current
206 computing unit
207 data connection
210 first eddy current sensor unit
212 magnetic field sensor
214 ASIC (application-specific integrated circuit)
216 FPGA (field-programmable gate array)
218 control element
220 memory element
222 connection surfaces
224 interconnecting wires
230 second eddy current sensor unit
232 eddy current coil
234 FPGA
236 control element
238 memory element
240 control device
242 excitation unit
244 topography measurement system
246 binding agent unit
248 binder

1. An inspection system for in-situ detection of characteristics within solidified powder material, comprising:
an eddy current-based inspection unit that can be arranged on a moving unit and that is arranged and configured to detect an electromagnetic material property of solidified powder material by means of an eddy current inspection so that conductivity differences within the solidified powder material can be detected in order to identify characteristics,
the inspection unit comprising a first eddy current sensor unit being arranged and configured to identify a characteristic having a first characteristic size greater than or equal to a size threshold, and
wherein the inspection unit comprises a second eddy current sensor unit that is arranged and configured to identify a collection of characteristics with a second characteristic size smaller than the size threshold.

2. The inspection system according to claim 1, wherein
the first eddy current sensor unit has a first inspection resolution and the second eddy current sensor unit has a second inspection resolution, the first inspection resolution being one or more of: higher than the second inspection resolution; and an order of magnitude higher than the second inspection resolution.

3. The inspection system according to claim 1,
the size threshold is between one or more of; 15 μm and 100 μm; and 20 μm and 50 μm.

4. The inspection system according to claim 1, wherein
the first eddy current sensor unit is or comprises a magnetic field sensor, and/or
the second eddy current sensor unit is or comprises an eddy current coil.

5. The inspection system according to claim 1, wherein the inspection unit is arranged and configured to detect the electromagnetic material property by means of an eddy current inspection during the solidification.

6. The inspection system according to claim 1, comprising:
a control device that is coupled to the inspection unit by signals and is adapted to generate an adaptation signal based on an identified property, the adaptation signal representing an adaptation strategy of the manufacturing system for adapting the property.

7. The inspection system according to claim 1,
the inspection unit being arranged and configured to identify an adapted characteristic on the basis of the adaptation signal, and/or
the control device is adapted to generate a second adaptation signal based on the identified adapted property, the second adaptation signal representing a second adaptation strategy of the manufacturing system for further adapting the adapted property.

8. The inspection system according to claim 1, comprising:
an excitation unit for causing the eddy current in the solidified powder material, wherein in normal operation the first eddy current sensor unit and/or the second eddy current sensor unit is/are arranged between the excitation unit and a test surface.

9. The inspection system according to claim 1, comprising a topography measurement system for determining a topography of the solidified powder material, adapted to generate a topography signal characterizing a topography image representing a distance of the solidified powder material to the inspection unit, wherein the characteristic is further identified based on the topography image.

10. The inspection system according to claim 1, wherein the first eddy current sensor unit and the second eddy current sensor unit are arranged offset to one another.

11. The inspection system according to claim 1, wherein the first eddy current sensor unit and/or the second eddy current sensor unit have individual sensors that are arranged and configured such that they can be supplemented by at least one further individual sensor.

12. The inspection system according to claim 1, comprising an application-specific integrated circuit coupled by signals to the inspection unit and adapted to amplify, digitize, filtering and/or providing for further processing.

13. The inspection system according to claim 1, wherein the control device is adapted to identify a component edge of the component based on output signals of the first and/or second eddy current sensor unit.

14. A manufacturing system for additively producing a component by means of solidifying a powder material, comprising:
a build chamber in which the powder material can be arranged,
a solidification unit which is arranged and configured to solidify the powder material,
a movement unit arranged in a movable manner above the powder material to be solidified, and
an inspection system according to claim 1, wherein the inspection unit is arranged on the movement unit.

15. The manufacturing system according to claim 14, wherein the movement unit is a coating unit for forming a powder bed surface.

16. A method for in-situ detection of characteristics within solidified powder material, comprising:
detecting an electromagnetic material property of solidified powder material by means of an eddy current inspection so that conductivity differences within the solidified powder material are detected in order to identify characteristics,
wherein a first eddy current sensor unit is used to identify a characteristic having a first characteristic size that is greater than or equal to a size threshold, and
wherein a second eddy current sensor unit is used to identify a collection of characteristics with a second characteristic size smaller than the size threshold.

17. The method according to claim 16, comprising the steps of:
generating an adaptation signal based on an identified characteristic, the adaptation signal representing an adaptation strategy of a manufacturing system for adapting the characteristic, and
controlling the manufacturing system with the adaptation signal in order to adapt the characteristic.
